(19) United States
(12) Patent Application Publication
(10) Pub. No.: US 2005/0049939 A1
(43) Pub. Date: Mar. 3, 2005

(54) Method and system for creating navigational information for an electronic store from virtual and master catalog links

(75) Inventors: Winnie W. N. Lai, Markham (CA); Paul K. H. Yu, Toronto (CA)

Correspondence Address: Jeffrey S. LaBaw;International Business Machines, 11400 Burnet Rd., Austin, TX, 78758, US

(73) Assignee: INTERNATIONAL BUSINESS MACHINES CORPORATION, ARMONK, NY (US)

(21) Appl. No.: 10/651,725

(22) Filed: Aug. 29, 2003

(51) Int. Cl. G06F 17/60

(52) U.S. Cl. 705/27

(57) ABSTRACT

A method for generating navigational links for linking catalog information for presentation to a user of a store in an electronic commerce system, comprising: defining master links between one or more child and parent items of the catalog information; generating first navigational links corresponding to the master links; defining virtual links between selected ones of the child items and parent items; generating second navigational links corresponding to the virtual links; and, joining the first and second navigational links to generate the navigational links.

### FIELD OF THE INVENTION

This invention relates generally to electronic commerce, and more particularly to the creation of product catalog navigational links for on-line electronic stores.

### BACKGROUND

Few technologies have revolutionized business more than the advent of the Internet. Merchants all over the world have been quick to realize that the Internet's true value is not in people's ability to browse the World Wide Web (“Web”) or send e-mail, but rather, in the new opportunities it creates for enhancing business processes, reducing costs and increasing profits through electronic commerce (“e-commerce”). Thus, e-commerce not only includes on-line transactions, it also encompasses technology to redefine old business models in order to maximize customer value. Not only are merchants adjusting their business processes to align with new technologies, they are fundamentally changing their organizations to be customer service and customer-satisfaction focused. Customers can order products or services on-line, check availability of the products, and follow their orders through the entire production process.

E-commerce systems currently exist that allow a merchant to establish an “electronic store” for selling products to customers over a computer network such as the Internet. Merchants use computers to publish information about their products on one or more electronic Web pages (e.g., text and graphics displayable on a computer screen) and to elicit product orders from customers. Likewise, customers use computers to access information describing products and to communicate orders to a merchant. Moreover, with the increasing popularity and accessibility of the Internet, and particularly the Web, the number of merchants using and desiring to use the Web to market and sell products is growing rapidly.

Now, e-commerce is traditionally carried out over a network such as the Internet using an e-commerce server networked with purchasers and merchants. The e-commerce server provides

substantially all of the functionality needed to establish the electronic store and carry out buying and selling over the Internet. This includes storing product catalog information provided by merchants, accepting requests for information from prospective purchasers, and accepting and processing orders. The e-commerce server may be operated by a merchant or a service provider. For example, rather than operate their own e-commerce servers, smaller merchants typically purchase e-commerce services provided by a service provider (or host). In this case, the service provider owns and maintains the e-commerce server and distributes configuration, operation, and maintenance costs across the subscriber merchants to realize economies of scale.

The electronic store itself typically includes a collection of Web pages which describe merchants' product offerings and which include on-line forms allowing customers to place orders. Customers use Web browsers installed on their personal computers to access the Web pages of these electronic stores to examine product catalogs containing information about available products and to submit product orders.

To facilitate customer review of product catalogs, the electronic store provides navigational tools for moving between the Web pages comprising the product catalog. These navigation tools may include product search functions, hyperlinks, site maps, product indices, and overall site design and organization. The electronic store and its product catalogs must have consistent navigational links to move between the Web pages of the catalog to keep customers oriented. For example, a product search may provide a link directly to an end product skipping over intermediary product catagories. If the end product page is not properly linked to a product catalog start page, the customer may not be able to navigate back to that start page and may become frustrated.

One problem encountered by merchants attempting to operate electronic stores is the tedious job of periodically adding or deleting categories of products and reorganizing products into different categories within their product catalogs. When making such changes, the underlying navigational tools must also be updated.

For example, many on-line catalogs presenting inventories of electronic stores use a top-down menu approach wherein an initial catalog page appearing on a customer's computer screen lists general product categories. If a user selects one of the general categories, another page appears on the computer screen presenting a narrower subordinate menu of product lines. Thus, a user navigates from high level menus to lower level menus, eventually reaching a page that describes an individual product. This type of menu navigation is popular on the Internet and on other networks, because it is easy for customers to understand, and allows customers to reach a particular product in a convenient and timely manner. However, top-down menu style catalogs are difficult to design and maintain. This is because each of the pages of such a catalog typically includes multiple hyperlinks, each hyperlink providing a precise reference to another page. As a result, a change to one page may require changes to many other pages, creating a complicated and tedious editing job. More specifically, to effectively use the Web for advertising and selling products, merchants must create and edit not only the categories and products presented on a page, but also the hyperlinks tying a set of Web pages together such that a user can navigate the pages conveniently. This process is tedious, time consuming, inefficient, and highly susceptible to introducing errors, especially when altering hyperlinks of a large set of Web pages.

The cost of maintaining an electronic store is thus affected by the means used to update the Web pages and navigational tools comprising the store. Existing Web page development tools are often not well suited to the task of developing and managing the content of these stores as they often lack the required functionality and flexibility. These tools are often burdensome or require a high level of technical knowledge or both. To address this problem, existing methods of establishing electronic stores use template Web pages to automate the process. However, this solution is often inadequate as a merchant's inventory typically fluctuates greatly, and electronic product catalogs and navigational tools require frequent updating due to, for example, changes in marketing strategy, changes in product availability and price, the introduction of new products or product lines, upcoming promotions, or product discontinuances.

A need therefore exists for a method and system for creating and maintaining product catalog navigational information that is both flexible and efficient. Accordingly, a solution that addresses, at least in part, the above and other problems is desired.

### SUMMARY

According to one aspect of the invention there is provided a method for generating navigational links for linking catalog information for presentation to a user of a store in an electronic commerce system, comprising: defining master links between one or more child and parent items of the catalog information; generating first navigational links corresponding to the master links; defining virtual links between selected ones of the child items and parent items; generating second navigational links corresponding to the virtual links; and, joining the first and second navigational links to generate the navigational links.

Preferably, for maintenance, the method further includes the step of changing ones of the navigational links in response to changes in corresponding ones of the master and virtual links.

Preferably, the master links have a tree structure.

Preferably, the catalog information is one or more Web pages.

Preferably, the child items and the parent items are product Web pages and product category Web pages, respectively.

Preferably, the master, virtual, and navigational links are hyperlinks.

Preferably, the master links define the store.

Preferably, the store is selected from the group consisting of a profile store and an operational store.

In accordance with further aspects of the present invention there is provided an apparatus such as an e-commerce server system having a database system, a method for adapting these systems, as well as articles of manufacture such as a computer readable medium having program instructions recorded thereon for practising the method of the invention. Advantageously, the virtual links facilitate the automatic creation and synchronization of the navigational catalog links for the electronic store. This improves the flexibility and efficiency of creating and maintaining product catalog navigational information.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating an exemplary electronic commerce system adapted for implementing an embodiment of the invention;

FIG. 2 is a diagram illustrating the logical structure of a catalog for an electronic store in accordance with an embodiment of the invention;

FIG. 3 is a diagram illustrating the logical structure of a catalog with virtual links for navigation in accordance with an embodiment of the invention; and,

FIG. 4 is a flow chart illustrating operations of modules within an electronic commerce server for generating navigational links for linking catalog information for presentation to a user of an electronic store, in accordance with an embodiment of the invention.

It will be noted that throughout the appended drawings, like features are identified by like reference numerals.

### DETAILED DESCRIPTION OF THE PREFERRED EMBODIMENTS

The following detailed description of the embodiments of the present invention does not limit the implementation of the invention to any particular computer programming language. The present invention may be implemented in any computer programming language provided that the operating system (“OS”) provides the facilities that may support the requirements of the present invention. A preferred embodiment is implemented in the JAVA™ computer programming language (or other computer programming languages such as C or C++ in conjunction with JAVA™). (JAVA and all JAVA-based trademarks are the trademarks of Sun Microsystems Corporation.) Any limitations presented would be a result of a particular type of operating system or computer programming language and would not be a limitation of the present invention.

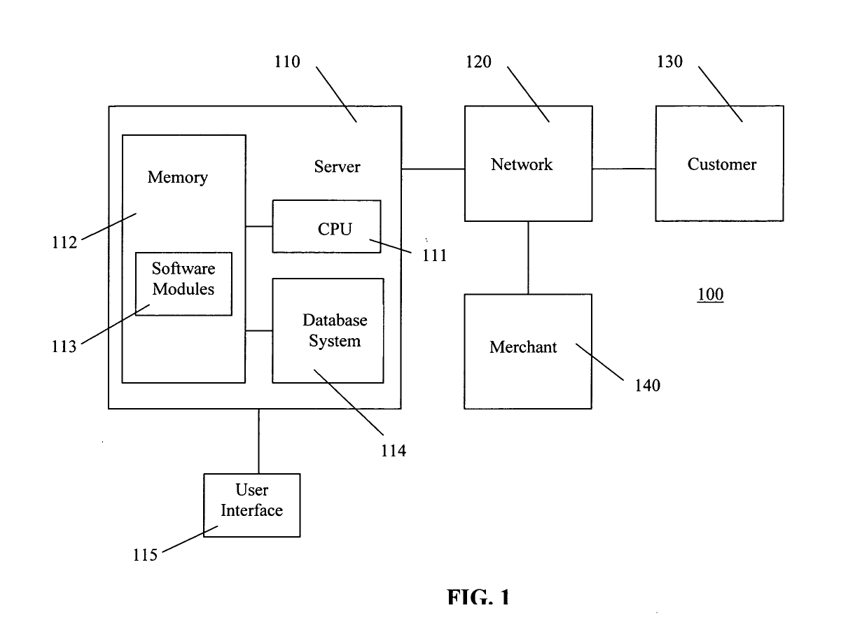

FIG. 1 is a block diagram illustrating an exemplary e-commerce system 100 adapted for implementing an embodiment of the invention. The e-commerce system 100 includes an e-commerce server system 110 communicating with merchant 140 and customer 130 systems over a network 120, such as the Internet. The e-commerce server system 110 includes a database system 114 for storing and accessing product catalog information for one or more merchants and provides navigational, content searching, and transactional functionality. The merchant system 140 may be a server and may include the e-commerce server system 110. The server 110 is adapted to provide product catalog and navigational information in accordance with the present invention. The customer system 130 may be a personal computer with a Web browser for accessing the product catalog and navigational information presented by the server 110 over the network 120 as one or more Web pages.

Transactional functionality provided by the server 110 includes the capability to carry out actions needed to complete a purchase and sale over the network 120. For example, the server 110 may accept a credit card number from a customer and contact the credit card vendor to verify that the account has sufficient credit to complete the purchase of a product having a given price. Once authorization is received, the server 110 may send messages to a banking institution that debits the customer's account and credits that of the merchant, completing the purchase.

Other transaction functionality may include: arranging to have the selected product shipped; and/or other order fulfillment functions, such as implementing a customer satisfaction survey along with product delivery, and storing the results for presentation and analysis.

The product catalog includes information pertaining to the products offered for sale by the merchant, including product names, manufacturers, colors, sizes, and prices. It may also include multimedia information concerning the product, including text, audio, graphic, animation and video data. Moreover, the product catalog includes navigational information allowing the customer to navigate among the product catalog information. The server 110 may also store data concerning merchants including warranty, guarantee, and merchandise return information, as well as background information regarding the merchant. In general, the product catalog is provided to the server 110 by the merchant who may update the product catalog at any time over the network 120.

The database system 114 includes a database management system (“DBMS”) and a database and is stored in the memory 112 of the server 110. It will be appreciated that the database system 114 may be shipped or installed without the database to or by end users. In general, the DBMS is adapted to read a query generated by the server 110 in response to a customer request for product catalog information submitted through a Web page. The DBMS then executes the query against the database and provides a query result to the server 110 for presentation to the customer. It will be appreciated that the database system 114 may be stored in the memory 112 of the server 110 or stored in a distributed data processing system (not shown).

An example of a suitable DBMS is the DB2™ Universal Database Management System product sold by IBM™. The DBMS is a software layer interposed between the actual database (i.e. the data as stored for use by the CPU 111 of the server 110) and the users of the system. The DBMS is responsible for handling database transactions thus shielding users from the details of any specific computer hardware or database implementation. Using relational techniques, the DBMS stores, manipulates and retrieves data in the form of table-like relations typically defined by a set of columns or attributes of data types and a set of rows (i.e. records or tuples) of data. The standard database query language for dealing with relational databases implemented by most commercial DBMSs is the Structured Query Language (“SQL”).

The server 110 includes a central processing unit (“CPU”) 111 operatively coupled to memory 112 which also stores an operating system (not shown) for general management of the system 110. An example of a suitable server system 110 is an IBM™ iSeries™ computer. The server 110 includes computer executable programmed instructions for directing the server 110 to implement the embodiments of the present invention. The programmed instructions may be embodied in one or more software modules 113 resident on the server 110. Alternatively, the programmed instructions may be embodied on a computer readable medium (such as a CD disk or floppy disk) which may be used for transporting the programmed instructions to the memory 112 of the server 110. Alternatively, the programmed instructions may be embedded in a computer-readable, signal-bearing medium that is uploaded to a network by a vendor or supplier of the programmed instructions, and this signal-bearing medium may be downloaded to the server 110 from the network by end users or potential buyers.

The CPU 111 of the server 110 is typically coupled to one or more devices 115 for receiving user or customer queries and for displaying the results of the queries to users over the network 120. User queries may be transformed into a combination of SQL commands for producing one or more tables of output data which may be incorporated in one or more Web pages for presentation to the user. The CPU 111 is coupled to memory 112 for containing programs and data such as base tables or virtual tables such as views or derived tables. The memory 112 may include a variety of storage devices including internal memory and external mass storage typically arranged in a hierarchy of storage as understood to those skilled in the art.

As will also be understood by those skilled in the art, the e-commerce server 110 may include a number of separate servers depending on merchant requirements. For example, the e-commerce server 110 may include separate Web presentation, Web application, transaction, data, security, and edge servers.

As mentioned above, an important concept in e-commerce applications is that of the “store”. A store represents the virtual area where business is conducted on the Web. For example, a merchant may establish a store on the Internet where the customers may purchase or exchange goods or services. Frequently a single store is not enough to capture all of a merchant's marketing strategies. For example, a merchant may have many brands which target different market segments.

Thus, it is frequently important to ensure that the stores on the site share the same infrastructure or commerce assets, such as presentation, business logic, catalog, fulfillment, etc. However, sometimes not all these characteristics can be shared. For example, while two stores may have many products in common, some products may only be available in one of the stores, some Web pages may also be distinct, etc., for other commerce assets.

By storing and accessing commerce assets (e.g. catalog information, presentation information, etc.) using a path infrastructure, which may be referred to as a “storepath”, the controlled sharing of selected commerce assets for a selected set of stores on a site may be facilitated. To control costs and improve efficiency, it is important that store specific and shared store assets share the same infrastructure, so that the same tools can be used to manage the shared and non-shared store assets. Advantageously, such a storepath infrastructure allows the merchant to decide whether a commerce asset is to be shared among stores at the time of site creation or dynamically after the site is created. This improves the flexibility of the merchant's marketing strategies.

A storepath is somewhat similar to a shell path within a UNIX™ operating system. UNIX is a trademark of The Software Foundation, Inc. That is to say, a store specifies that its commerce assets may be looked up along a specified path. However, there are several distinctions as follows:
1. The path does not list directories in the file system, rather, it lists other stores. Thus, a store's storepath instructs the server's runtime logic to look for commerce assets in the stores listed in the storepath, in the order indicated.
2. Several storepaths may be defined for each store, one for each type of commerce asset.
3. Several stores may be listed in the storepath for each store asset and a precedence for the stores can be set.

If a store's storepath references another store, then the latter store may be referred to as a “profile store” for the former store. Thus, storepaths and profile stores are created to support different types of commerce assets including: catalogs; information presentation logic; marketing information; business logic; business relationships; inventory item definitions; inventory tracking; prices; calculation methods; currency related information; unit of measure related information; and, language and locale related information.

Different stores can often be very similar in look and feel or products sold and only have small differences in presentation (e.g. store trademarks, service marks, or other store indicia) or pricing. Advantageously, profile stores allow for all the common data to be stored in one location and thus avoid having to maintain the same data in many places. This improves efficiency. The profile store can store all the common data (e.g. JAVA Server Pages™ (“JSPs”) for presentation, catalog for products sold, etc.), each store can reference the profile store, and each store can store its store specific data (e.g. store logo, prices for products sold, etc.). Thus, profile stores simplify store creation and store management functions and improve marketing flexibility.

A profile store may model specific business practices (e.g. business to consumer (B2C) or business to business B2B) and define one or a set of commerce assets such as catalogs, prices and business processes. A profile store can be managed using server 110 based tools but, in general, it does not support shopping activities (e.g. a customer cannot shop in a profile store). An “operational store”, that is, a store that a customer can shop in, can look up a commerce asset from one or more profile stores for a specific asset type. The storepath concept is implemented by a software module or modules 113 within the server 110 and by storepath tables within the server's database. The storepath tables may include, for example, the following columns: Store ID, Commerce Asset Type, and Alternate Store ID.

The concepts of storepath and profile store enable the sharing of store resources such as configuration data and business processes between stores. For example, an operational store may draw command, view, and calculation information from its associated profile store. In addition, catalog and pricelist information may be drawn from a catalog profile store. Thus, the data path from the operational store to the profile store represents a “profile storepath” and the data path from the operational store to the catalog profile store represents a “catalog profile storepath”. It should be noted that both profile and operational stores share the same object model. There is no restriction that an operational store cannot be used in the storepath. To improve performance further, the storepaths may be stored in cache memory 112 within the server 110. Thus, for each store, a different set of storepaths can be defined for different commerce assets used by the store.

Advantageously, the present invention provides efficient and flexible operations for maintaining navigational links within product catalogs. These operations are described further herein below. The term “catalog” will refer to a collection of “products” or “product categories”. Product categories are organized in a hierarchical manner with products belonging to product categories. An “item” in a catalog may thus refer to a product or a product category. The term “product manager” will refer to a store administrator having the authority to update the catalog for that store. The term “current store” will refer to the store whose assets are being accessed, that is, the Web pages describing the store's products are either being viewed by a customer or they are being edited by a product manager. The term “catalog profile store” will refer to the store which contains catalog assets that are intended to be shared. And, the term “leaf store” (or operational store) will refer to the lowest level store in a store path relationship referencing a catalog profile store.

Catalogs may be shared among stores in accordance with various catalog profile store, leaf store, profile store, and storepath semantics including the following:
1. The shared catalog is defined for the profile store.
2. Items (i.e. products and product categories) can be either in a leaf store or in a profile store or stores but in the same catalog defined from the profile store. Items in the profile store are to be shared by all leaf stores of the profile store.
3. A customer in a leaf store may view or search all items defined in the leaf store in union with the items from the profile store, subject to a catalog filter.
4. When working with the catalog from a leaf store, a store administrator acting as a product manager may view or search items in the leaf store in addition to profile store items. The product manager may edit all items defined in the leaf store, but may not edit profile store items. Profile store items are read-only entities for the product manager of the leaf store.
5. A product manager for a leaf store may not view, search or edit items in another leaf store that is not in its storepath even though the catalog is shared from the profile store.
6. When working with the catalog from a catalog profile store, the product manager may view, search or edit items defined only in the profile store. Items from the leaf stores do not appear in the catalog profile store.

Advantageously, a catalog can be shared amongst stores where the shared assets are placed in a profile store and updates are immediately applied to all stores who have the profile store in its storepath. Each leaf store can also add catalog items to the shared catalog but these will only be available to that specific store.

As mentioned, a store's catalog consists of all items (such as products and product categories) defined in the store, plus all items defined in the profile stores in its catalog storepath. However, a store administrator is responsible for the content of only those catalog entries defined in the administered store. Thus, a store administrator may add new items to the catalog for the administered store even though many of the items in the catalog are defined in a catalog profile store. New products may be added to any categories, and new categories may be added as well.

From the leaf store, new product categories can be created and added to the catalog by a product manager and these categories will only be visible in the leaf store. New items can be added to either the new categories or directly to existing categories provided by the profile store catalog. These products will also be only visible to the particular leaf store.

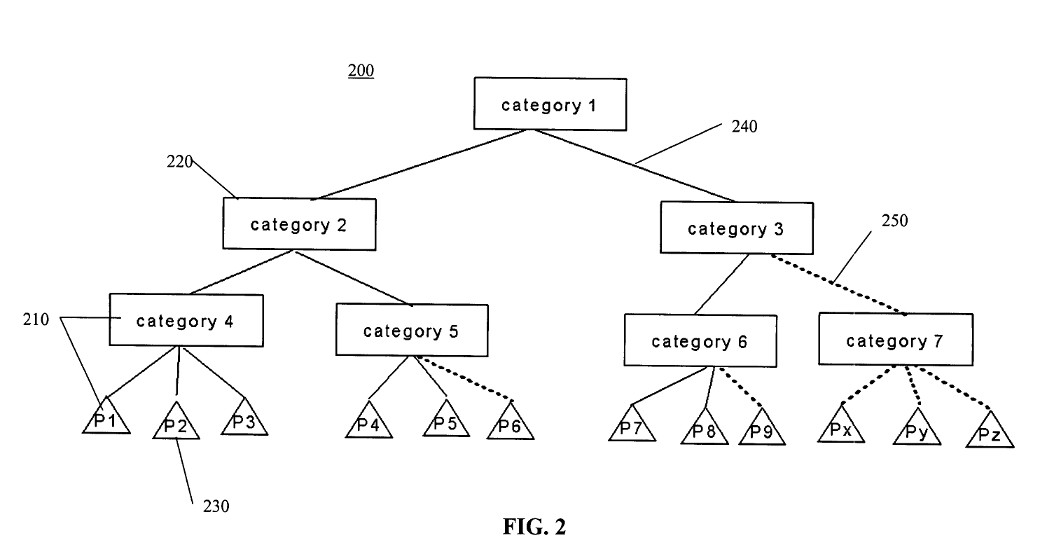

FIG. 2 is a diagram illustrating the logical structure of a catalog 200 for an electronic store in accordance with an embodiment of the invention. The catalog 200 includes items 210 that may be product categories 220 or products 230. In FIG. 2, the solid lines 240 represent the profile store catalog while the dashed lines 250 represent the categories and items only visible to the leaf store. The administrator of the profile store can view and edit categories 1 through 6 and items P1 through P5, P7, and P8. The product manager for the leaf store can view all products and categories but can only edit category 7 and products P6, P9, Px, Py, and Pz. The product manager for the leaf store can also create prices for all products.

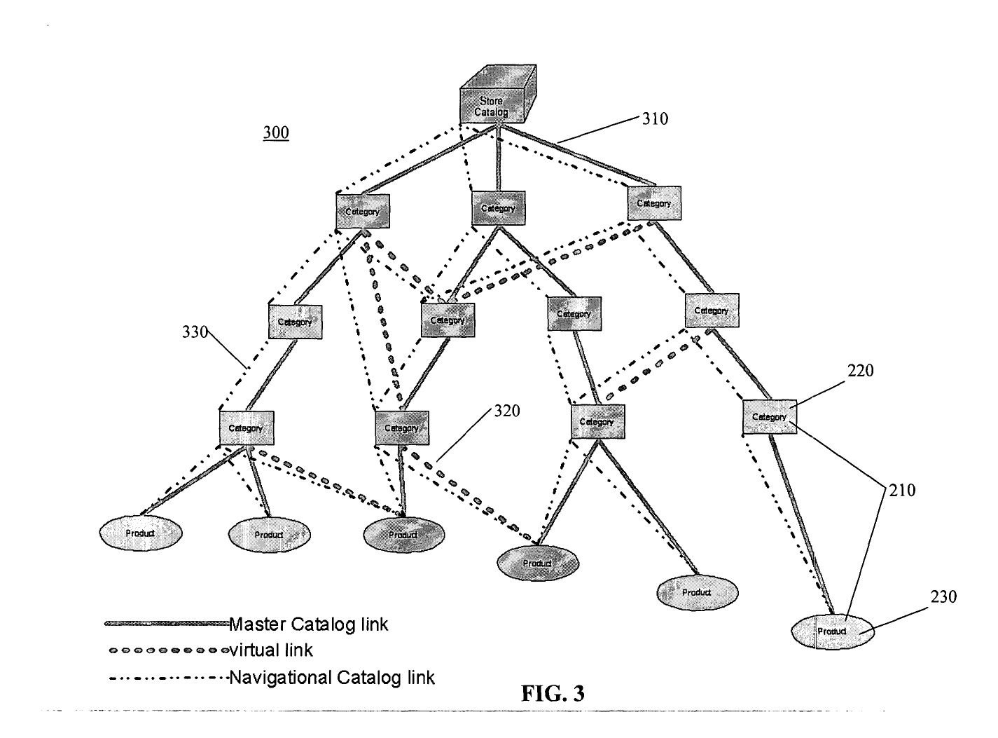

FIG. 3 is a diagram illustrating the logical structure of a catalog 300 with virtual links 320 for navigation in accordance with an embodiment of the invention. Again, the catalog 300 includes items 210 that may be product categories 220 or products 230. The catalog 300 includes a master catalog and a navigational catalog. The master catalog has master catalog links 310 (shown as solid lines in FIG. 3) between selected items 210. The navigational catalog has navigational catalog links 330 (shown as dotted lines in FIG. 3) between selected items 210. Advantageously, the present invention provides one tool for maintaining links of both the master and navigational catalogs of an electronic store without affecting the content of those catalogs.

The master catalog is a hierarchical arrangement of nodes or items 210 having a proper tree structure (i.e. not an acyclic or cyclic graph or network structure). Each child node or item has a master catalog link 310 to a single parent node or item. The purpose of the proper tree structure is to avoid ambiguity. For example, each child item allows only one parent item's business rules (i.e. a commerce asset) to be applied. Thus, the master catalog supports the sharing of commerce assets between stores in accordance with the storepath concept described above.

The navigational catalog is a hierarchical arrangement of nodes or items 210 having a tree structure, but not necessarily a proper tree structure (i.e. may include a graph or network structure). Each child node or item may have navigational catalog links 330 to one or more parent nodes or items. The tree structure indicates how a user may navigate to a given child or leaf item. The child or leaf item may be accessed through multiple paths. Thus, the navigational catalog supports navigation among the catalog information or Web pages comprising the electronic store.

According to the present invention, each store is provided with a master catalog and at least one navigational catalog. In general, the navigational catalog has navigational catalog links 330 that include the master catalog links 310 plus additional or “virtual” links 320 (shown as dashed lines in FIG. 3) connecting selected child items to multiple parent items. Thus, the virtual links 320 supplement the master catalog links 310 to improve navigation among catalog information or Web pages as provided by the navigational links 330. When master catalog links 310 and virtual links 320 are created or modified, navigational catalog links 330 are generated and synchronized as follows.

First, when a master catalog link 310 is created, a navigational catalog link 330 is created. The navigational catalog links 330 are thus aligned with the master catalog links 310.

Second, when a master catalog link 310 is changed, its corresponding navigational catalog link 330 is changed. Thus, navigational catalog links 330 remain aligned with master catalog links 310 when the latter is revised or updated.

Third, the deletion of a master catalog link 310 is not allowed to ensure that no “dangling node” is produced in the master catalog. Thus, for example, customers using the electronic store will always be able to navigate back to a start page.

Forth, when a virtual link 320 is created, a navigational catalog link 330 is created. To improve navigation, virtual links 320 may supplement the navigational catalog links 330. For example, a virtual link 320 may provide a link to an end product page that skips over intermediary product pages in the master catalog.

Fifth, when a virtual link 320 is changed, its corresponding navigational catalog link 330 is changed. The navigational catalog links 330 are thus aligned with the virtual links 310.

Sixth, when a virtual link 320 is deleted, its corresponding navigational catalog link 330 is deleted. Again, the navigational catalog links 330 are aligned with the virtual links 310.

Seventh, the deletion of a node or item 210 is only allowed if the node has no child node. Thus, for example, customers using the electronic store will always be able to navigate back to a start page.

And, eighth, if a node or item 210 is deleted, then the master catalog link 310 and all virtual and navigational catalog links 320, 330 between the node and its parent are deleted. Again, for example, customers using the electronic store will always be able to navigate back to a start page.

Advantageously, the virtual links 320 facilitate the automatic creation and synchronization of the navigational catalog links 330 for the electronic store. This improves the flexibility and efficiency of creating and maintaining product catalog navigational information.

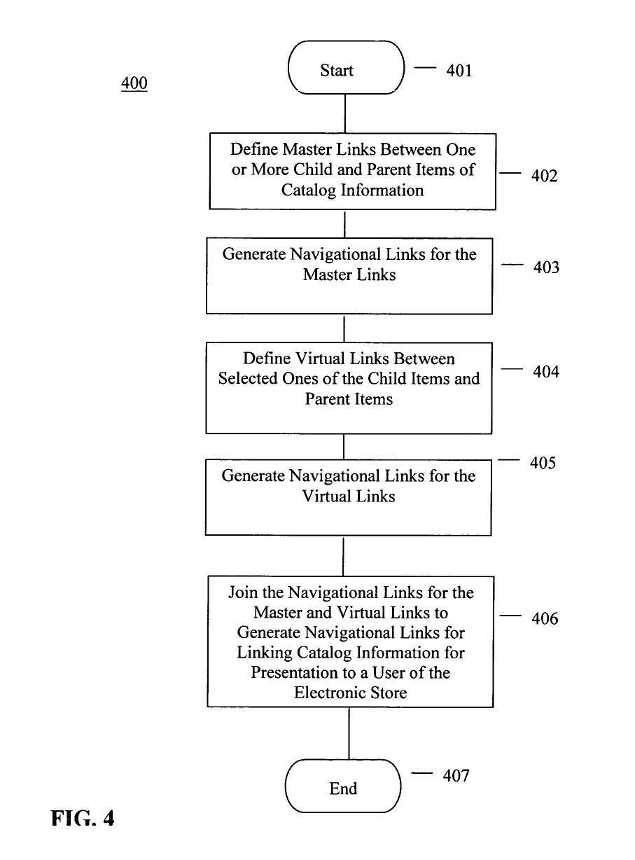

FIG. 4 is a flow chart illustrating operations 400 of modules 113 within an electronic commerce server 110 for generating navigational links 330 for linking catalog information for presentation to a user of an electronic store, in accordance with an embodiment of the invention.

At step 401, the operations 400 start.

At step 402, master links 310 are defined between one or more child and parent items 210 of the catalog information. A product manager may employ a user interface 115 coupled to the server 110 and database system 114 for defining master links 320, for example, during the creation of a product category 220 or product 230. Preferably, the master links 310 have a tree structure (e.g. a proper tree structure). Preferably, the catalog information is one or more Web pages. Preferably, child items and parent items 210 are product Web pages and product category Web pages, respectively. Alternatively, the master links 310 may be predetermined and stored in or provided by the database of the database system 114.

At step 403, navigational links 330 are generated for the master links 310. This operation may be performed by one or more software modules 113 and/or by the DBMS of the database system 114. Alternatively, these navigational links 330 may be predetermined and stored in or provided by the database of the database system 114.

At step 404, virtual links 320 are defined between selected ones of the child items and parent items 210. A product manager may employ the user interface 115 coupled to the server 110 and database system 114 for defining virtual links 320.

At step 405, navigational links 330 are generated for the virtual links 320. This operation may be performed by one or more software modules 113 and/or by the DBMS of the database system 114.

At step 406, navigational links 330 for the master and virtual links 310, 320 are joined to generate navigational links 330 for linking catalog information for presentation to a user of the electronic store. Preferably, for maintenance, the navigational links 330 are changed in response to changes in corresponding master and virtual links 310, 320. Preferably, the master, virtual, and navigational links 310, 320, 330 are hyperlinks. Preferably, the master links 310 define the electronic commerce store. Preferably, the electronic commerce store is selected from the group consisting of a profile store and an operational store.

At step 407, operations 400 end.

While this invention is primarily discussed as a method, a person of ordinary skill in the art understands that the apparatus discussed above with reference to a computer-implemented e-commerce server and system may be programmed to enable the practice of the method of the invention. Moreover, an article of manufacture for use with a data processing system, such as a pre-recorded storage device or other similar computer readable medium including program instructions recorded thereon may direct the data processing system to facilitate the practice of the method of the invention. It is understood that such apparatus and articles of manufacture also come within the scope of the invention.

The embodiment(s) of the invention described above is(are) intended to be exemplary only. The scope of the invention is therefore intended to be limited solely by the scope of the appended claims.

1. A method for generating navigational links for linking catalog information for presentation to a user of a store in an electronic commerce system, comprising:
defining master links between one or more child and parent items of said catalog information;
generating first navigational links corresponding to said master links;
defining virtual links between selected ones of said child items and parent items;
generating second navigational links corresponding to said virtual links; and,
joining said first and second navigational links to generate said navigational links.

2. The method of claim 1 and further comprising the step of changing ones of said navigational links in response to changes in corresponding ones of said master and virtual links.

3. The method of claim 1 wherein said master links have a tree structure.

4. The method of claim 1 wherein said catalog information is one or more Web pages.

5. The method of claim 4 wherein said child items and said parent items are product Web pages and product category Web pages, respectively.

6. The method of claim 4 wherein said master, virtual, and navigational links are hyperlinks.

7. The method of claim 1 wherein said master links define said store.

8. The method of claim 7 wherein said store is selected from the group consisting of a profile store and an operational store.

9. An electronic commerce server system for generating navigational links for linking catalog information for presentation to a user of a store, said server system comprising:
a user interface for: (a) defining master links between one or more child and parent items of said catalog information; (b) defining virtual links between selected ones of said child items and parent items; and, (c) changing ones of said master and virtual links; and,
a database management system for: (a) generating first and second navigational links corresponding to said master and virtual links, respectively; (b) joining said first and second navigational links to generate said navigational links; and, (c) changing ones of said navigational links in response to changes in corresponding ones of said master and virtual links.

10. The electronic commerce server system of claim 9 wherein said master links have a tree structure.

11. The electronic commerce server system of claim 9 wherein said catalog information is one or more Web pages.

12. The electronic commerce server system of claim 11 wherein said child items and said parent items are product Web pages and product category Web pages, respectively.

13. The electronic commerce server system of claim 11 wherein said master, virtual, and navigational links are hyperlinks.

14. The electronic commerce server system of claim 9 wherein said master links define said store.

15. The electronic commerce server system of claim 14 wherein said store is selected from the group consisting of a profile store and an operational store.

16. A computer program product having a computer readable medium tangibly embodying computer executable code for directing an electronic commerce system to generate navigational links for linking catalog information for presentation to a user of a store, said product comprising:
code for defining master links between one or more child and parent items of said catalog information;
code for generating first navigational links corresponding to said master links;
code for defining virtual links between selected ones of said child items and parent items;
code for generating second navigational links corresponding to said virtual links; and,
code for joining said first and second navigational links to generate said navigational links.

17. The computer program product of claim 16 and further comprising code for changing ones of said navigational links in response to changes in corresponding ones of said master and virtual links.

18. The computer program product of claim 16 wherein said master links have a tree structure.

19. The computer program product of claim 16 wherein said catalog information is one or more Web pages.

20. The computer program product of claim 19 wherein said child items and said parent items are product Web pages and product category Web pages, respectively.

21. The computer program product of claim 19 wherein said master, virtual, and navigational links are hyperlinks.

22. The computer program product of claim 16 wherein said master links define said store.

23. The computer program product of claim 22 wherein said store is selected from the group consisting of a profile store and an operational store.

24. An article including a computer readable modulated carrier signal being usable over a network, and means embedded in the computer readable modulated carrier signal for directing an electronic commerce system to generate navigational links for linking catalog information for presentation to a user of a store, said article comprising:
means in the medium for defining master links between one or more child and parent items of said catalog information;
means in the medium for generating first navigational links corresponding to said master links;
means in the medium for defining virtual links between selected ones of said child items and parent items;
means in the medium for generating second navigational links corresponding to said virtual links; and,
means in the medium for joining said first and second navigational links to generate said navigational links.

25. The article of claim 24 and further comprising means in the medium for changing ones of said navigational links in response to changes in corresponding ones of said master and virtual links.

26. The article of claim 24 wherein said master links have a tree structure.

27. The article of claim 24 wherein said catalog information is one or more Web pages.

28. The article of claim 27 wherein said child items and said parent items are product Web pages and product category Web pages, respectively.

29. The article of claim 27 wherein said master, virtual, and navigational links are hyperlinks.

30. The article of claim 24 wherein said master links define said store.

31. The article of claim 30 wherein said store is selected from the group consisting of a profile store and an operational store.
